(19) United States
(12) Patent Application Publication
(10) Pub. No.: US 2013/0199000 A1
(43) Pub. Date: Aug. 8, 2013

(54) Two-Piece Molded Garment Button

(71) Applicants: Caleb C. Crye, Brooklyn, NY (US); Michael Circosta, Brooklyn, NY (US)

(72) Inventors: Caleb C. Crye, Brooklyn, NY (US); Michael Circosta, Brooklyn, NY (US)

(73) Assignee: LineWeight LLC, Brooklyn, NY (US)

(21) Appl. No.: 13/368,821

(22) Filed: Feb. 8, 2012

(51) Int. Cl. A44B 1/18; B23P 17/04; A44B 1/06

(52) U.S. Cl. 24/379.1; 24/104; 29/428

(57) ABSTRACT

A garment button for insertion into a button hole to secure two segments of material together, is described. Generally speaking, the button is a two piece device and includes a first body forming an outer perimeter of the button, the first body being sized to fit into a desired button hole and having an opening defined inside of the outer perimeter, and a second body detachably fixed within the opening, wherein the second body divides the opening to define two distinct and separate openings. The two bodies snap together after passing through a custom strap or loop of material.

### TECHNICAL FIELD OF THE INVENTION

The present device relates to a button, button assembly and a method of use for the button and assembly. Particularly, the present device relates to a two-piece replaceable button.

### BACKGROUND OF THE INVENTION

Button-like objects have been found in the Indus Valley of ancient Pakistan and date back to around 2000 B.C. Originally, buttons were not used as fasteners, but rather as ornaments for clothing much like jewelry such as broaches are used today. Before buttons, people used pins, leather lacing and belts to secure clothing closed.

One impediment to using buttons as fasteners was that the button hole had yet been devised. Evidence dates the first button and button hole closure systems to the 13th century in Germany. This may have been a solution to the problem of how to secure clothing that was becoming more and more form-fitting, without having to resort to the danger of using sharp pins.

Buttons come in nearly an infinite number of sizes, colors and shapes and have been made from materials such as ivory, gold, brass, wood, plastics and even paper. But, whether mostly functional or purely aesthetic, little has changed in buttons over the many years.

As simple as the button and button hole concept is, the problem with most buttons is that they are not easy to replace. While many garments come with extra buttons sewn to an inside panel, the loss of a button still requires a trip to the dry-cleaners or at the very least home to find a needle and thread to attach a new button. A service will make you wait at least an hour if not longer for your garment and if doing it one's self, there is the trouble of positioning the button properly and threading a needle to complicate the matter.

The present device solves these and other problems associated with prior art buttons. By providing a button assembly which can be readily attached to a custom site without use of thread or any other material, the present device can replace a broken or lost button in a matter of seconds.

### SUMMARY OF THE INVENTION

There is disclosed herein an improved button and method of use which avoid the disadvantages of prior devices and methods while affording additional structural and operating advantages.

A garment button for insertion into a button hole to secure two segments of material together, is described and claimed. Generally speaking, the button comprises a first body forming an outer perimeter of the button, the first body sized to fit into a desired button hole and having an opening defined inside of the outer perimeter, and a second body detachably fixed within the opening, wherein the second body divides the opening to define two distinct and separate openings.

In various embodiments of the inventive button, many features are evident. For example, the second body is configured to snap-fit within the opening of the first body; the second body is configured to form a portion of the outer perimeter of the button; the first body and the second body are molded as a single component which can be separated; and, the surfaces of the two bodies are flush when formed into a button.

A method for securing at least two segments of material together using the inventive button is also described and claimed. Generally speaking, the method comprises the steps of providing a securing strap attached to a first segment of material, inserting a free portion of the securing strap into an opening of a first body, sliding a second body under the free portion of the securing strap, securing each of two ends of the second body to the first body thereby securing the first body to the securing strap, and inserting the secured first body into a button hole defined within a second segment of material.

In an embodiment of the method, the first body is first detached from the second body before the step of sliding a second body under the free portion of the securing strap.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a front perspective view of an embodiment of the present button attached to a garment;

FIGS. 2 and 3 are front face views of two distinct embodiments of the present button design;

FIGS. 4 and 5 are front face views of the buttons illustrated in FIGS. 2 and 3, respectively, showing one way in which the two pieces may be adjoined before use;

FIG. 6 is a perspective view of an embodiment of the present button design;

FIG. 7 is a back face view of the embodiment of the button illustrated in FIG. 3;

FIG. 8 is a side view of the embodiment of the button illustrated in FIG. 3;

FIG. 9 is a top side view of the embodiment of the button illustrated in FIG. 3;

FIG. 10 is a front perspective view of the two-piece embodiment of FIG. 5;

FIG. 11 is a front face view of the unassembled embodiment of FIG. 3;

FIG. 12 is a back face view of the unassembled embodiment of FIG. 11;

FIG. 13 is a side view of the unassembled embodiment of FIG. 11;

FIG. 14 is a top side view of the unassembled embodiment of FIG. 11;

FIG. 15 is an opposite side view of the unassembled embodiment of FIG. 14;

FIG. 16 is a perspective view of another embodiment of the present button design;

FIG. 17 is a back face view of the embodiment of the button illustrated in FIG. 16;

FIG. 18 is a side view of the embodiment of the button illustrated in FIG. 16;

FIG. 19 is a front perspective view of the two-piece embodiment of FIG. 4;

FIG. 20 is a front face view of the unassembled embodiment of FIG. 4;

FIG. 21 is a back face view of the unassembled embodiment of FIG. 4; and

FIG. 22 is a side view of the unassembled embodiment of FIG. 4.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

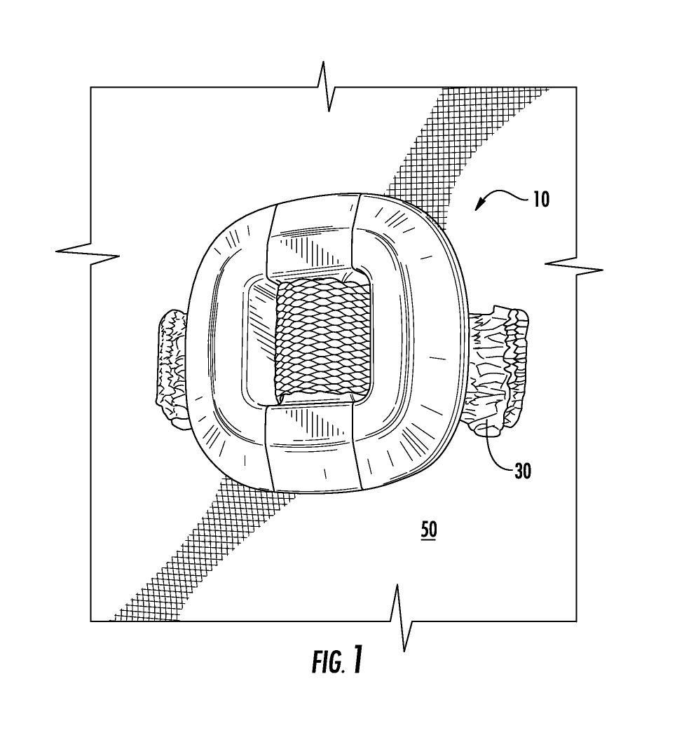

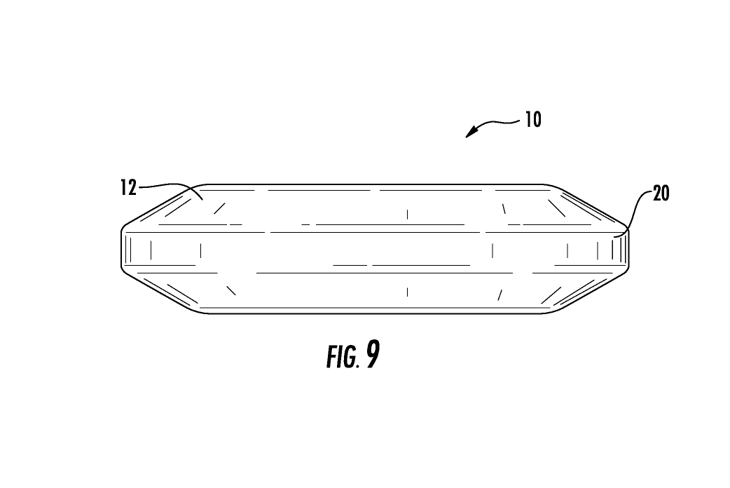

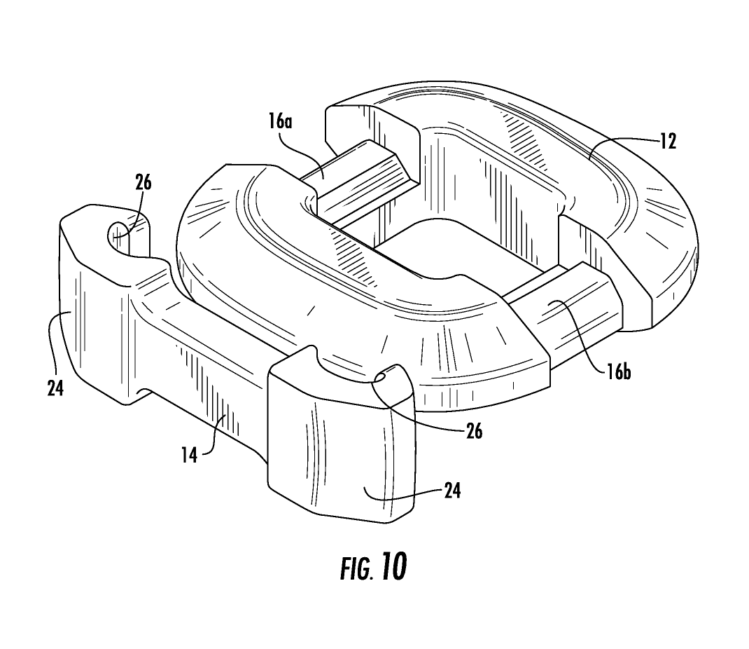

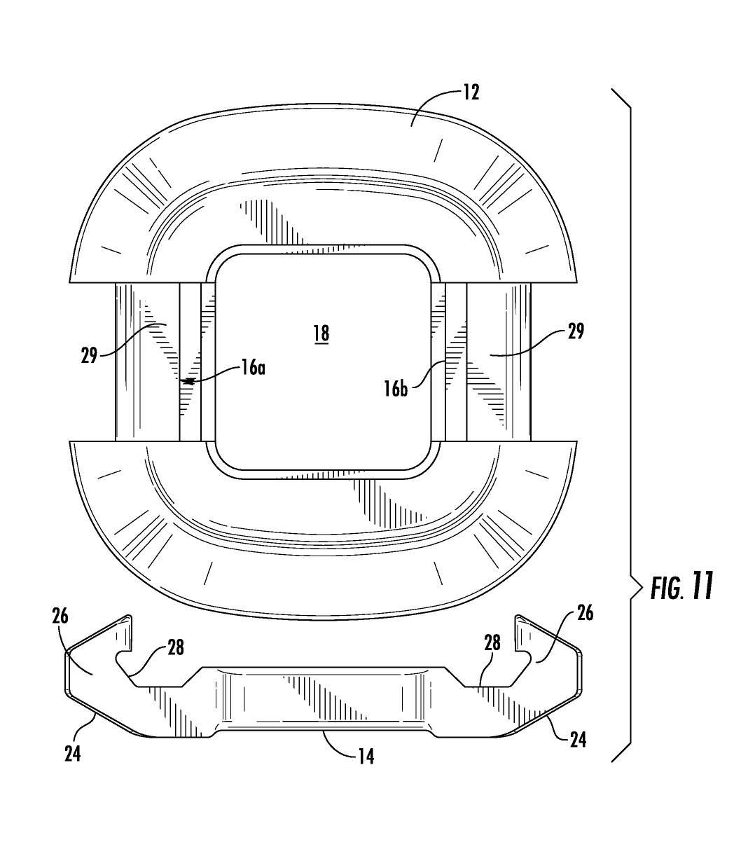

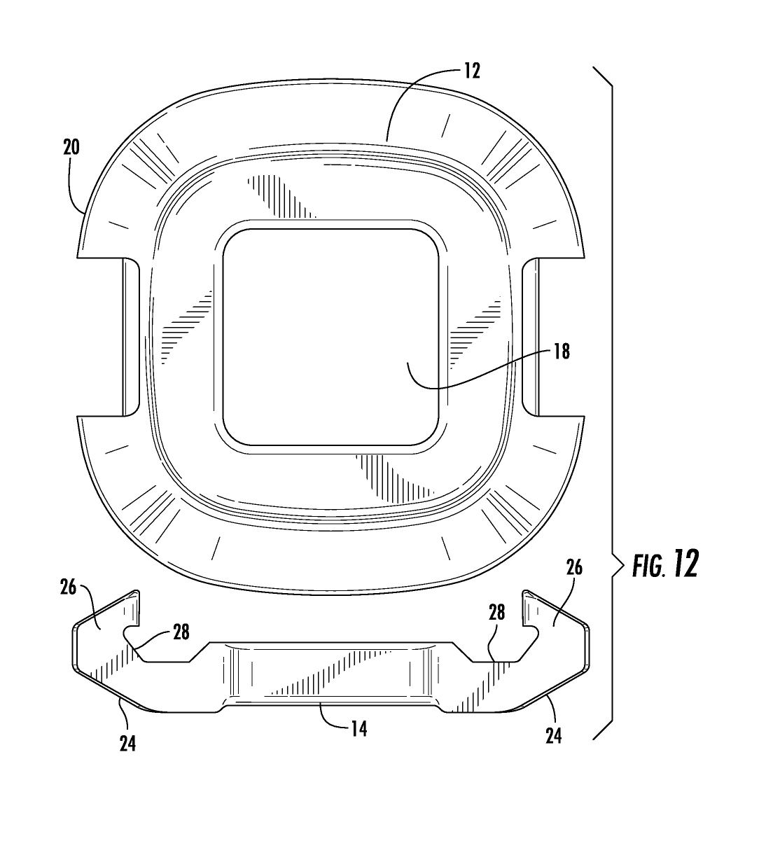

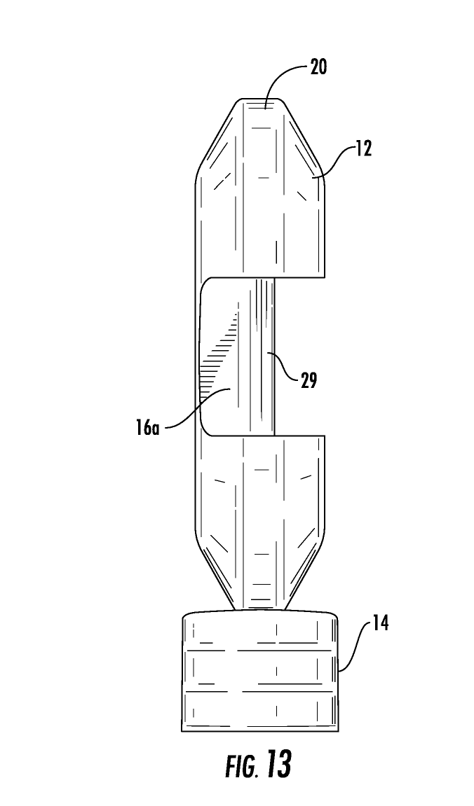

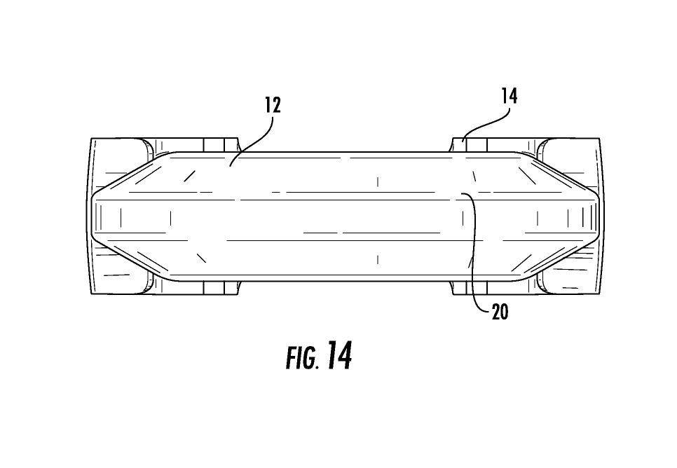

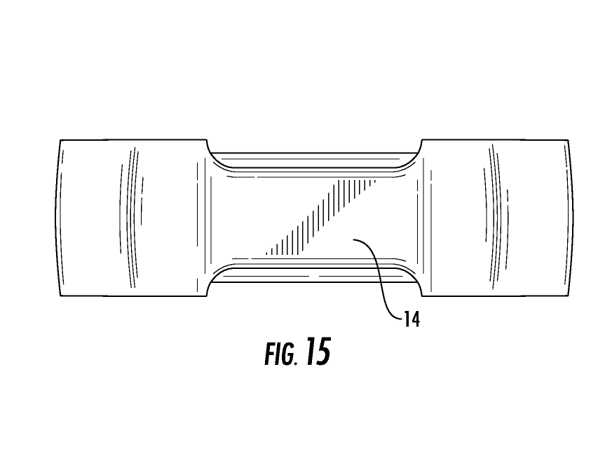

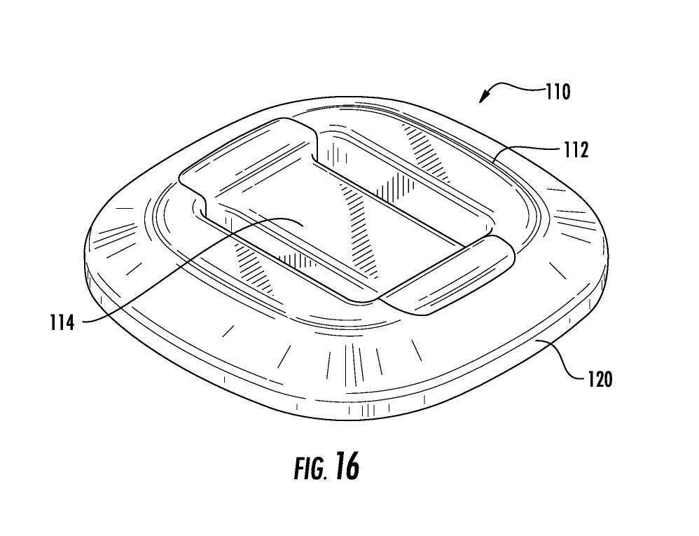

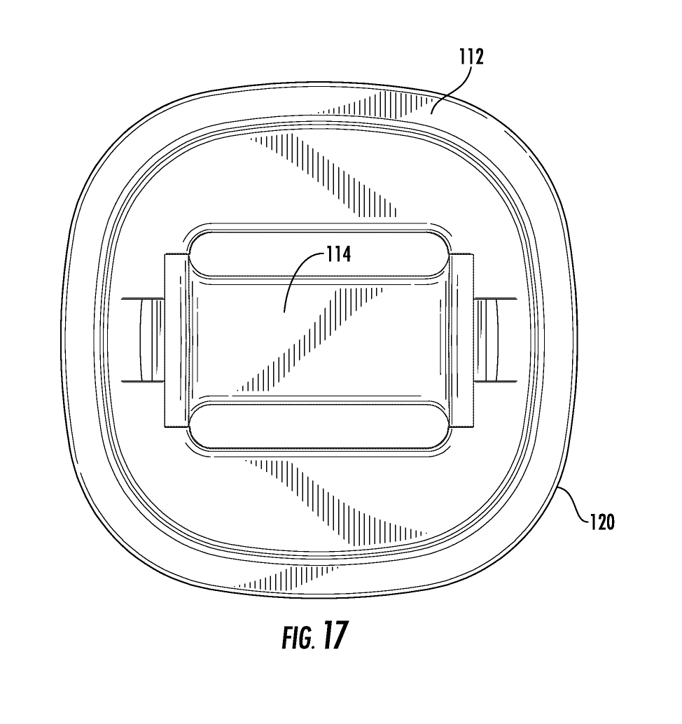

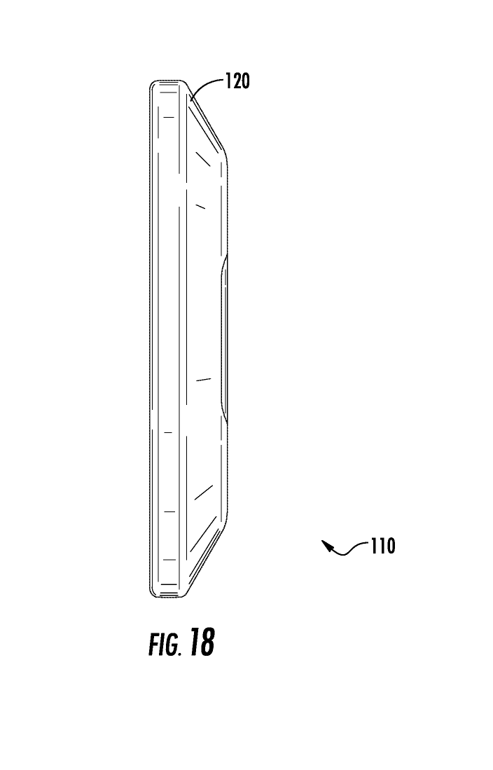

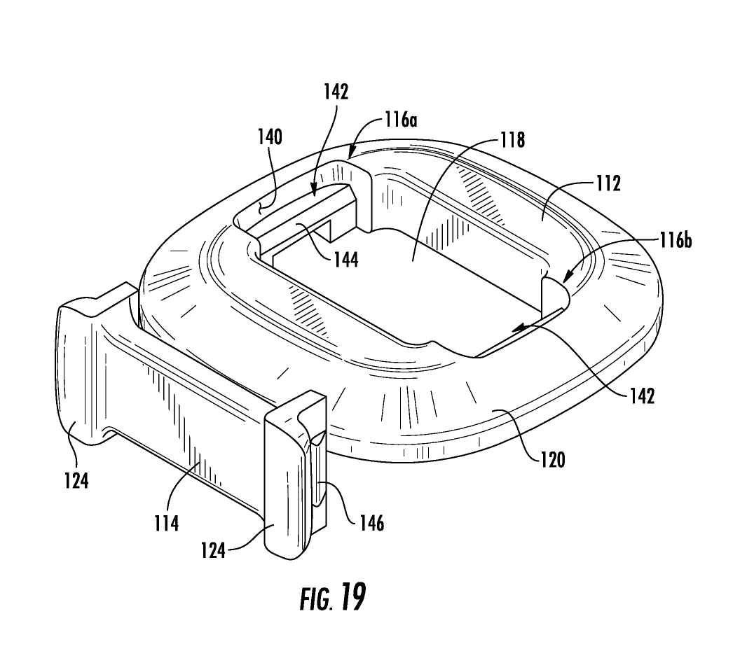

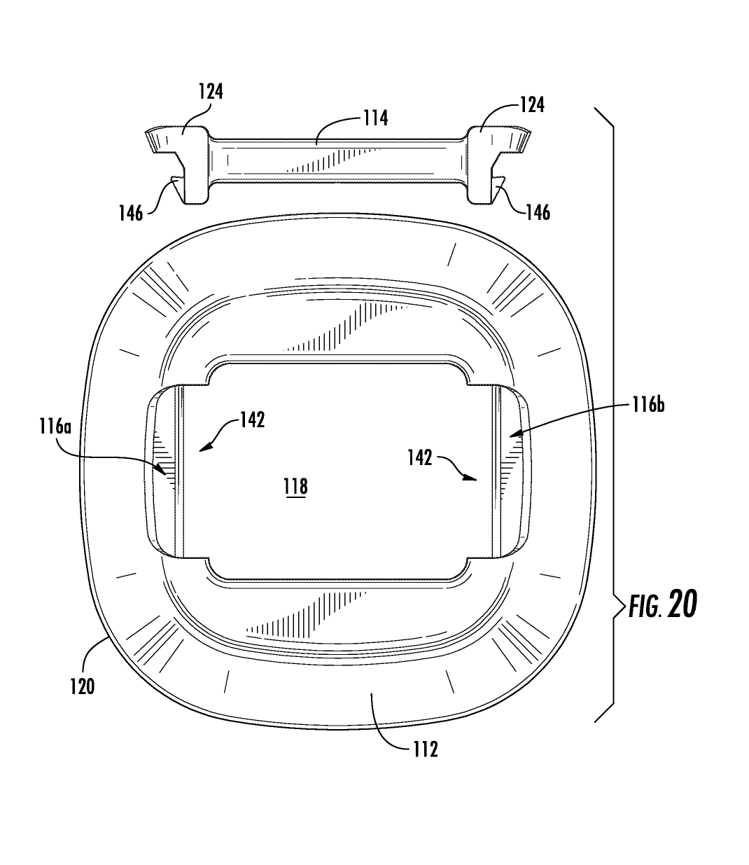

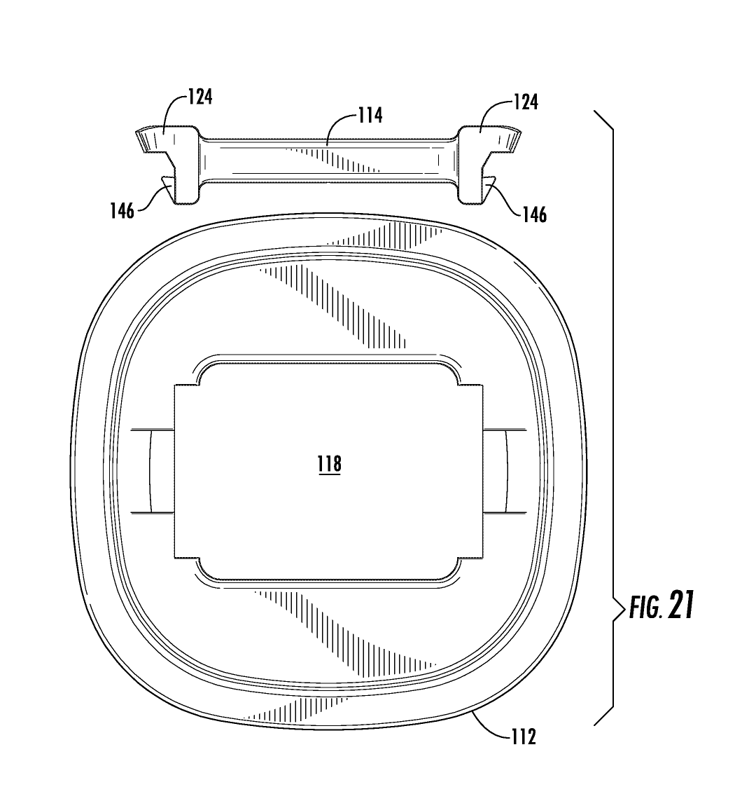

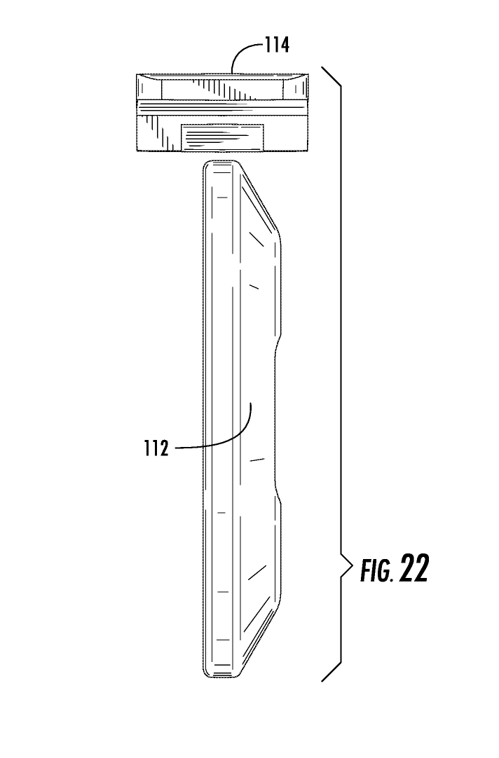

Referring to FIGS. 1-22, there is illustrated embodiments of a button, generally designated by the numerals 10 and 110. In each of the illustrated button configurations, 10 and 110, a two-piece replaceable assembly is shown. By “replaceable” it is meant that the buttons can be readily attached and detached from the custom button site without any additional materials. The “button site” is preferably a loop of material with either one attachment point or two attachment points (FIG. 1) on the subject garment. The disclosed buttons are ideal for use on garments where the buttons are subject to damage through excessive wear, impact, chemicals or the like. For example, use on uniforms and equipment for military, law enforcement, and sports are all particularly applicable. The loss of a button “in the field” can be quickly and easily remedied with use of present inventive buttons.

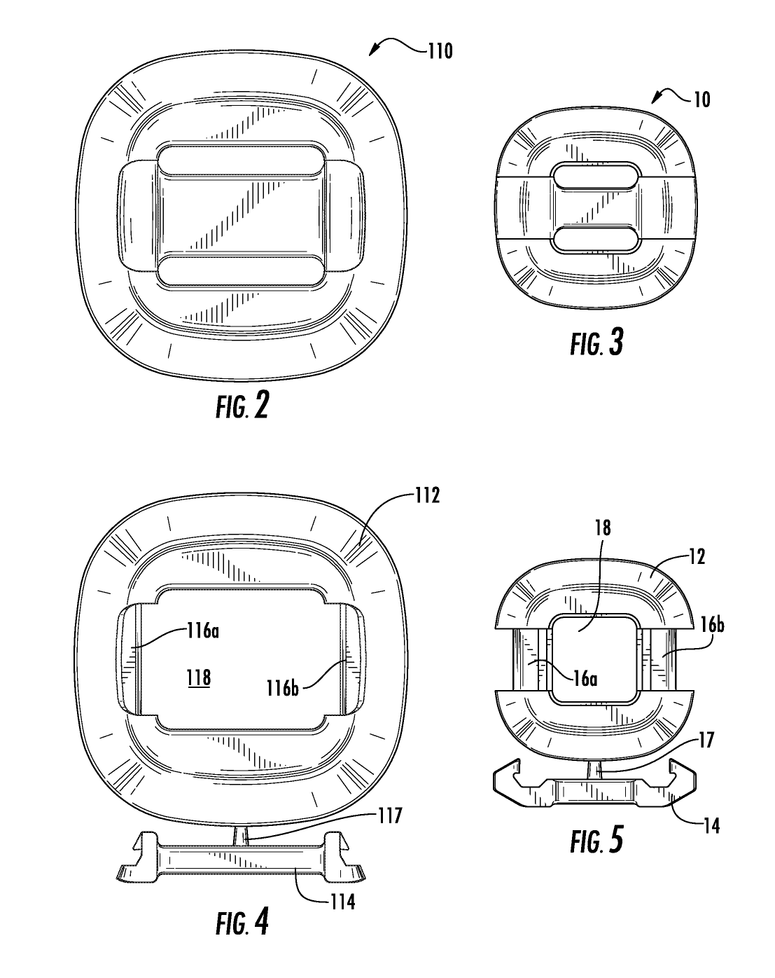

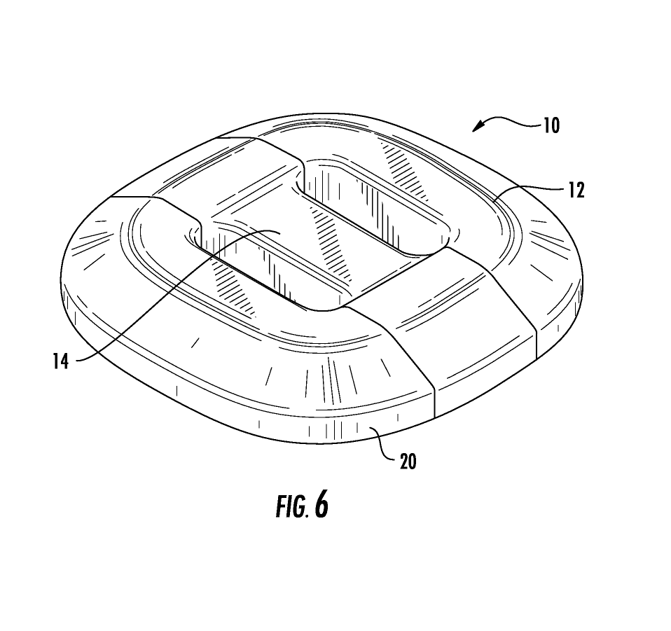

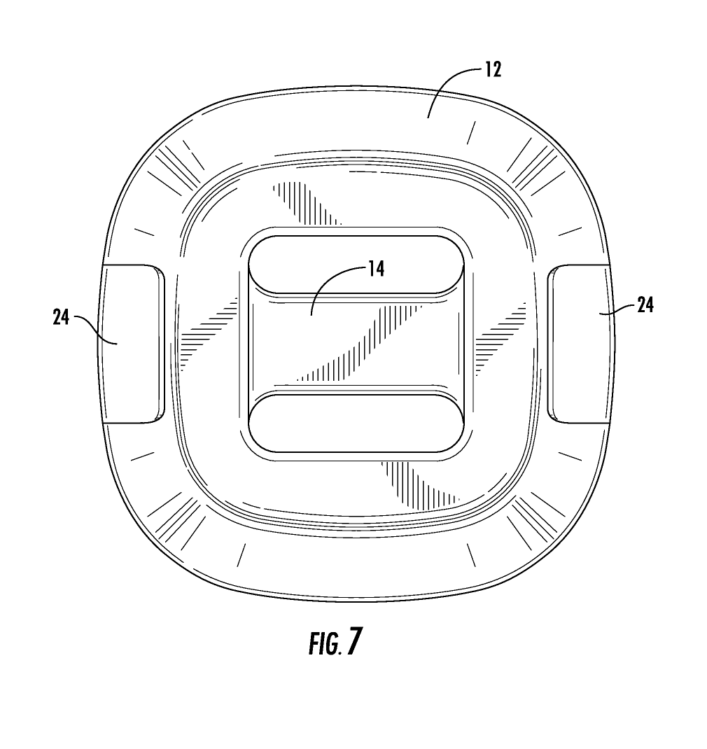

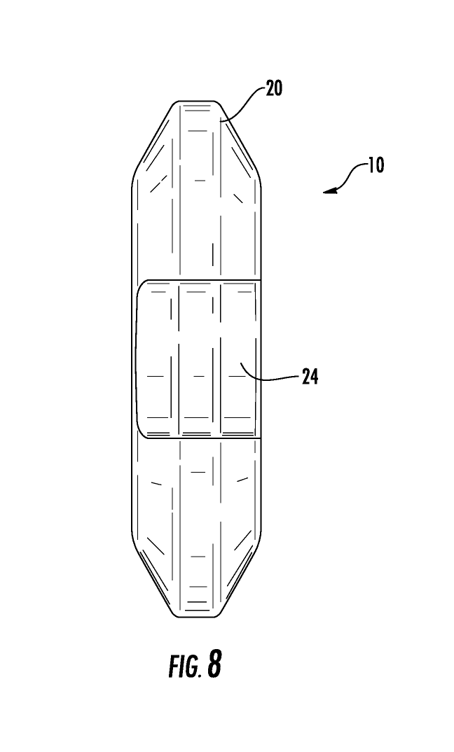

With reference to the embodiment of FIGS. 3 and 5-15, the illustrated button 10 has a first body 12 and a second body 14 which releasably secures to sections 16a and b of the first body 12. The two-piece configuration, as shown in FIG. 5, is preferably manufactured as a single component. The attachment of the two bodies together facilitates the use of the button 10 by preventing a user from having to search through a pocket, for example, for the separated components. By molding the two components as one, e.g., using injection molding techniques, the bridge 17 can be easily designed to separate with a twist of the components. The button 10 can be made in virtually any size or shape to accommodate a button-hole.

The first body 12 of button 10 includes an outer periphery 20 which should be small enough to be inserted within a particular button-hole (not shown), but large enough to prevent slipping back through the hole unexpectedly. The outer periphery 20 includes two sections 16a and b where the second body 14 attaches, as will be explained in greater detail below. At the approximate center of the first body 12 an opening 18 is formed. The size of the opening 18 is determined to allow a securing strap 30 (FIG. 1) to be at least partially inserted and retained.

Once the securing strap 30 is inserted, the second body 14 is positioned under the strap 30 and connected to the first body 12 at the two sections 16a and b. The second body 14 includes two ends 24 which are identical to allow for attachment to the first body 12 in either direction. Each end 24 includes a hook-like member 26 with an inner surface 28 that conforms to an upper surface 29 of the two sections 16a and b. The two ends 24 preferably clip onto the two sections 16a and b by hooking around an outer edge and underside of the first body 12. Securing one end first and then the other end is believed to be the most effective method for attachment. Once secured in place, the second body 14 prevents removal of the securing strap 30 from the opening 18 of the first body 12, effectively holding the button 10 in place on the garment 50 (FIG. 1).

The design of the ends 24, periphery 20, opening 18, sections 16a and b and other features of the button 10 shown in the many figures are for illustrative purposes only. Changes to these components can be easily made without departing from the general utility of the disclosed button 10. Such possible changes are exemplified in the illustration of a second embodiment, button 110, described below.

With reference to the embodiment of FIGS. 2, 4 and 16-22, the illustrated button 110 has a first body 112 and a second body 114 which releasably secures to sections 116 of the first body 12. The two-piece configuration, as shown in FIG. 4, is preferably manufactured as a single component. The attachment of the two bodies together facilitates the use of the button 110 by preventing a user from having to search through a pocket, for example, for the separated components. By molding the two components as one, e.g., using injection molding techniques, the bridge 117 can be easily designed to separate with a twist of the components. The button 110 can be made in virtually any size or shape to accommodate a button-hole.

The first body 112 of button 110 includes an outer periphery 120 which should be small enough to be inserted within a particular button-hole (not shown), but large enough to prevent slipping back through the hole unexpectedly. Unlike the embodiment of button 10 described above, the outer periphery 120 of button 110 is uninterrupted. At the approximate center of the first body 112 an opening 118 is formed. The size of the opening 118 is determined to allow a securing strap (not shown) to be at least partially inserted and retained. The opening 118 includes two sections 116a and b where the second body 114 attaches, as will be explained in greater detail below.

Once the securing strap 130 is inserted into the opening 118, the second body 114 is positioned under the strap 130 and connected to the first body 112 at the two sections 116a and b. The second body 114 includes two ends 124 which are identical to allow for attachment to the first body 112 in either direction. The two ends 124 preferably clip into the two sections 116a and b by abutting a surface 140 within recess 142 and clipping under a flange 144 using an angled-protuberance 146 of the second body 114. Placing the ends 124 of the second body 114 within the recesses 142 and pushing downward on the ends 124 will effectively “snap” the angled-protuberances 146 into place. Once secured, the second body prevents removal of the securing strap 130 from the opening 118 of the first body 112, effectively holding the button 110 in place on the garment.

The design of the periphery 120, opening 118, sections 116a and b, ends 124 and other features of the button 110 shown in the many figures are for illustrative purposes only. Changes to these components can be easily made without departing from the general utility of the disclosed button 110.

Another feature of the inventive buttons 10 and 110, is that an upper surface 60 (160 for button 110) of the second body 14 (114) is intentionally made flush to a corresponding upper surface 62 (162) of the first body 12 (112). In fact, the second body 14 (114) is intended to provide such aesthetic continuity along all surfaces to best look like an integral portion of the first body 12 (112). This feature also minimizes the possibility of catch-points on the resulting button which might snag material or result in the accidental disassembling of the two-piece configuration.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A garment button for insertion into a button hole to secure two segments of material together, the button comprising:
a first body forming an outer perimeter of the button, the first body sized to fit into a desired button hole and having an opening defined inside of the outer perimeter; and
a second body detachably fixed within the opening, wherein the second body divides the opening to define two distinct and separate openings.

2. The garment button of claim 1, wherein the second body snap-fits within the opening of the first body.

3. The garment button of claim 1, wherein the second body forms a portion of the outer perimeter of the button.

4. The garment button of claim 1, wherein the first body and the second body are molded.

5. The garment button of claim 4, wherein the first body and the second body are initially molded as a single piece.

6. The garment button of claim 5, wherein the first body and the second body remain attached to one another until needed as a button.

7. A method for securing at least two segments of material together, the method comprising the steps of:
providing a securing strap attached at each of two ends to a first segment of material and free along a portion of the strap between the two ends;
inserting the free portion of the securing strap into an opening of a first body;
sliding a second body under the free portion of the securing strap inserted into the opening of the first body;
securing each of two ends of the second body to the first body, thereby securing the first body to the securing strap; and
inserting the secured first body into a button hole defined within a second segment of material.

8. The method of claim 7, wherein the second body snaps onto the first body.

9. The method of claim 7, further comprising the step of detaching the first body from the second body before the step of sliding a second body under the free portion of the securing strap.

10. The method of claim 7, further comprising the step of removing a button attached to the securing strap before the step of inserting the free portion of the securing strap into an opening of a first body.

11. A button assembly comprising:
a two-piece button comprising a first body forming an outer perimeter and having an opening, and a second body detachably fixed within the opening to divide the opening into two separate and distinct openings; and
a securing strap attached by at least one of two opposing ends to a first segment of material to create a loop;
wherein the second body extends through each side of the loop of the securing strap and connects to the first body.

12. The button assembly of claim 11, wherein the first body has an upper surface and the second body has an upper surface and the upper surface of the second body is substantially flush with the upper surface of the first body when the second body is attached to the first body.

13. The button assembly of claim 11, wherein the first body has an upper surface and a peripheral surface, the second body has an upper surface and a peripheral surface, and the upper surface of the second body is substantially flush with the upper surface of the first body when the second body is attached to the first body and the peripheral surface of the second body is substantially flush with the peripheral surface of the first body when the second body is attached to the first body.
